(19) United States
(12) Patent Application Publication
(10) Pub. No.: US 2024/0043622 A1
(43) Pub. Date: Feb. 8, 2024

(54) PRODUCTION OF THIOPOLYMERS BY REACTIVE EXTRUSION

(71) Applicant: Arkema Inc., King of Prussia, PA (US)

(72) Inventors: Sangwoo PARK, King of Prussia, PA (US); Andrew POLLI, King of Prussia, PA (US)

(21) Appl. No.: 18/019,494

(22) PCT Filed: Aug. 3, 2021
(86) PCT No.: PCT/US2021/044278

§ 371 Date: Feb. 3, 2023

Related U.S. Application Data
(60) Provisional application No. 63/065,539, filed on Aug. 14, 2020.

(51) Int. Cl. C08G 75/14

(52) U.S. Cl. CPC C08G 75/14

(57) ABSTRACT

This process for synthesizing thiopolymers involves feeding elemental sulfur or sulfides and unsaturated hydrocarbons into an extruder. The extruder is comprised of a screw and a barrel. The screw is rotated so as to pressurize, heat and mix the sulfur or sulfides and unsaturated hydrocarbon to induce inverse vulcanization thereby producing thiopolymers such as polymeric polysulfides. The invented process can be accomplished by using sulfur which becomes molten at the conditions in the extruder or is preheated and unsaturated hydrocarbons as the starting material. The materials are fed through one or more extruders so as to induce mixing and reaction of the materials forming polysulfides.

### BACKGROUND OF THE INVENTION

The present invention relates to a process for producing thiopolymers, i.e. polymeric polysulfides. More specifically, the present invention relates to a process where polysulfides are produced by reactive extrusion. Polymeric polysulfides are obtained by the reaction of sulfur in the form of elemental sulfur or sulfides and unsaturated hydrocarbons via inverse vulcanization. Polymeric polysulfides are useful for a number of different applications. Polymeric polysulfides can potentially be used for lubricant additives, sulfiding agents, polymer processing aids, elastomer curing agents, vulcanization agents, bleaching agents, fillers, precursor for polythiols/polysulfides, optics, electrodes, fertilizer coating materials/ingredients, heavy metal removal materials, waste water treatment agents, asphalts/cements additives, collector for mining.

In conventional inverse vulcanization methods, polymeric polysulfide's are formed by reacting sulfur in the form of elemental sulfur or sulfide with unsaturated hydrocarbons in a batch-type reaction vessel. Specifically, a large amount of sulfur in the form of elemental sulfur or sulfide is placed in a reactor and then unsaturated hydrocarbons is added. The sulfur material reacts with the unsaturated hydrocarbon forming polymeric polysulfides. Such batch-type processes can require handling of high viscosity materials that complicate the operation of the process. When such batch-type processes are used, stirring of the reaction mixture can be difficult due to reaction mixture viscosity increase during the reaction.

Conventional batch type methods do not contemplate the advantage of using pressure and high shear forces created by an extruder to aid in performing the reaction of sulfur in the form of elemental sulfur or sulfides and unsaturated hydrocarbons via inverse vulcanization.

A process for producing polymeric polysulfides via inverse vulcanization is needed that has a shorter reaction time than previous processes. Furthermore, a process is needed that is a continuous process rather than a batch-type process.

### SUMMARY OF THE INVENTION

It is an object of the present invention to provide a process for producing polymeric polysulfides by means of reactive extrusion in order to provide a quicker process for producing polymeric polysulfides.

Another object of the present invention is to provide a continuous process for producing polymeric polysulfides so that polymeric polysulfides may be produced in a quick and efficient manner.

Another object of the present invention is to provide a continuous process for producing polymeric polysulfides that minimizes the effects of the high viscosity of the reaction products.

A further object of the present invention is to provide a simple, economical, and environmentally-friendly process for producing polymeric polysulfides.

A further object of the invention is to provide a process for producing polymeric polysulfides that provides for easy control of the physical properties of the resulting polymeric polysulfides by selection of the reactants, reactant feed point, reaction temperature and pressure, and feeding ratio(s).

According to the present invention, the foregoing and other objects are achieved by a process for producing polymeric polysulfides via inverse vulcanization by means of reactive extrusion. The process can be a one-step process that uses sulfur in the form of elemental sulfur or sulfides and unsaturated hydrocarbons as starting materials or it can be a multi-step process.

The reactive extrusion can occur is a single extruder with a single pass through the extruder, a single extruder with multiple passes through the extruder, or in a series of two or more sequential extruders. To enhance the purity of the polymeric poly sulfide produced, the extruder may be cleaned or purged prior to use. Following extrusion, the polymeric polysulfide can be further processed such as by scrubbing with scrubber solution, pelletized in a pelletizer, pulverized in a pulverizer or ball mill grinder, injection molded or formed into filament. The polymeric polysulfide as produced or after further processing can be can be still further processed such as by compounding, blending, and/or thermal treatment.

Additional objects, advantages and novel features of the invention will be set forth in part in the description which follows, and in part will become apparent to those skilled in the art upon examination of the following, or may be learned from practice of the invention. The objects and advantages of the invention may be realized and attained by means of the instrumentalities and combinations particularly pointed out in the appended claims.

### DETAILED DESCRIPTION OF THE PREFERRED EMBODIMENT

The invented process for manufacturing polymeric polysulfides involves the inverse vulcanization reaction of sulfur in the form of elemental sulfur or sulfides with unsaturated hydrocarbons to produce polymeric polysulfides. The inverse vulcanization reaction is achieve via reactive extrusion by passing the reactants through one or more extruders.

The one or more extruders can include different heating zones in an extruder, different heating regimes in sequential extruders and/or different heating zones and regimes in sequential extruders. Both the barrel and the die of the extruder or extruders can be heated or one can be heated or neither can be heated. Preferably, the extruder barrel and die temperatures range from about 90° C. to 250° C. Most preferably, the temperature of the extruder barrel and die is between about 140° C. and 220° C. The extruder die or dies may be heated or not heated.

An advantage of inverse vulcanization via reactive extrusion is better handling of released gas. For example, one safety concern with inverse vulcanization is handling potentially toxic gas (i.e., H₂S) formed during the polymerization reaction. By placing a suction system(s) near gas releasing points of the extruder or extruders, the dangerous gas can be safely removed and treated or disposed of.

An advantage of inverse vulcanization via reactive extrusion is better handling of released volatile compound. For example, one safety concern with inverse vulcanization is the handling of potentially toxic volatile liquid (i.e., S₂Cl₂) formed during the polymerization reaction. By placing suction system(s) near volatile compound release points of the extruder or extruders, the dangerous chemical can be safely removed and treated or disposed of.

An advantage of inverse vulcanization via reactive extrusion is better handling of reaction materials or products that can exhibit high viscosities. For example in inverse vulcanization, the viscosity of the reaction product can be so high that it inhibits the ability of mixers in batch reactors to mix the reactants.

An advantage of inverse vulcanization via reactive extrusion is continuously production of reaction materials or products. For example in inverse vulcanization, continuously feeding of reactive raw materials can produce polymeric polysulfides.

Although the same chemical reaction takes place in the invented process as in conventional processes, the environment of the reaction is entirely different. Because of the temperature of the extruder and the pressure created by the die or screw of the extruder, the sulfur material in the form of elemental sulfur or sulfides in the extruder melts or liquefies or remains liquefied. The sulfur material can be feed to the extruder as a solid which can optionally be pre-heated to enhance feed of the sulfur material to the extruder. The pre-heating of the sulfur material can comprise heating to a temperature less than or up to the melting temperature of the sulfur material.

This allows more intimate contact between the sulfur in the form of elemental sulfur or sulfides with unsaturated hydrocarbons even at the high viscosities that may occur during the inverse vulcanization reaction. As a result, the reaction can be a continuous reaction and the efficiency of the reaction is higher than for a batch reaction. This allows the reaction to be accomplished in a shorter time as compared with conventional batch reaction technology.

After the extrusion, the polymeric polysulfide product is can be further process such as treated with a scrubber solution to remove residual toxic gas such as H₂S or potentially toxic volatile liquids such as S₂Cl₂, pelletized in a pelletizer to enable ease of handling or pulverization in a pulverizer or ball mill grinder to enable ease of handling. In addition to or in combination with scrubbing and/or pelletizing, the extrudate polymeric polysulfide product can be subjected to additional processing such as compounding, blending, or thermal treatment depending on the end use of the polymeric polysulfides. Optionally, the produced polymeric polysulfide compounds can be pulverized such as in a ball mill grinder to enhance removal of residual gas such as H₂S.

The sulfur reactant material can be elemental sulfur or sulfides. The sulfides can be di- or poly-sulfide, and more specifically, the sulfides can be selection of alkyl di- or poly-sulfides, aromatic di- or poly-sulfides, hetero-atomic di- or poly-sulfides, alkylphenol di- or poly-sulfide, linear di- or poly-sulfides, cyclic di- or poly-sulfides, branched di- or polysulfides, et cetera. The sulfides can be used alone or with elemental sulfur for inverse vulcanization. The sulfide linkages from polysulfides can be dissociated at elevated temperature and react with unsaturated hydrocarbon monomers. Examples of polysulfides include: amylphenol disulfide, oligo- or poly-(para-tert-amylphenol disulfide), oligo- or poly-(para-tert-butylphenol disulfide), liquid polysulfide polymers, lipoic acid, varacin. The elemental sulfur or sulfides reactant can be in the form of a solid such as powder, a slurry or a liquid.

The unsaturated hydrocarbon reactant can be selected from aliphatic unsaturated hydrocarbons, aromatic unsaturated hydrocarbons having heteroatomic or cyclic structures. Exemplary unsaturated hydrocarbons include, dicyclopentadiene (DCPD), cyclododecatriene (CDT), divinyl benzene (DBV), diisopropenylbenzene (DIB), ethylidene norbornene (ENB), soybean oil, linseed oil, limonene, myrcene, farnesol, farnesene, diethyleneglycol dimethacrylate. The unsaturated hydrocarbon reactant can be a single unsaturated hydrocarbon or a mixture of one or more unaerated hydrocarbons. The unsaturated hydrocarbon may be in the form of a solid such as a powder, a liquid, or a gas.

Any extruder screw design may be used in the invented process. Different screws may be selected to obtain different desired compression ratios. Preferably, the extruder or extruders have a compression ratio of between approximately 1.5:1 and 3:1. Most preferably, the compression ratio is about 2.5:1. Also, different screw configurations provide different types of mixing. Some examples of screw designs include those with no mixing sections, one mixing section, and two mixing sections. There is not a significant difference between mixing versus non-mixing designs as used in the present invention.

Still further, the polymeric polysulfides can be manufactured by using single or twin screw extruders. If a single screw extruder is used, it is preferable that it has a single mixing zone, a 2.5:1 compression ratio screw, and a non-heated die attachment.

Although a single screw extruder performs adequately for the above mentioned purposes, preferably, a twin screw mixer is used. A twin screw mixer provides a more stable flow, easier feeding, and better control over the process. This is attributed to the positive pumping effect and lack of compression caused by the twin screw mixer.

The process of the present invention can employ one or more extruder passes comprising a single extruder or multiple extruders is sequence. The one or more extruders can include heating provisions that can provide varied temperatures from one extruder to another, or can be provide a temperature gradient along a single extruder. The temperatures of the one or more extruders can vary from about 120° C. to 250° C. Preferably, from about 170° C. to 220° C.

The reactant materials, the sulfur material and the unsaturated hydrocarbon may be feed to the extruder simultaneously through separate injection sites, as a premixed combination or sequentially at injection ports oriented along the barrel of the one or more extruders. The reactive extrusion of the present invention allows for wide variability in the feed process and timing of the injection of the reactants into the extruder where reaction occurs which allows for enhance control over the reaction and thus the polymeric polysulfide produced.

Optionally, a catalyst may be fed to the one or more extruders independently through one or more separate injection sites or as a component of a premix combination. The catalyst may be selected from zinc diethyldithiocarbamate, zinc dimethyldithiocarbamate, zinc stearate, sodium diethyldithiocarbamate, iron diethyldithiocarbamate, cobalt diethyldithiocarbamate, copper diethyldithiocarbamate, nickel diethyldithiocarbamate, thiram, thiuram, guanidine, 2-mercaptobenzothiazole, zinc 2-mercaptobenzothioazole, thiourea, benzothiazole sulfenamide, isopropylxanthate and mixtures thereof. The catalyst may be feed at rates of from about 0.1 to 20 wt % based upon the total weight of the reactants. Most preferably, the catalyst may be feed at rates of from about 1 to 5 wt % based upon the total weight of the reactants.

The extrusion process provides usefulness in commercial applications as a continues process for the production of polymeric polysulfides via inverse vulcanization. The process of the present invention allows for a wide range of easily variable reaction conditions to allow for production of a wide range of polymeric polysulfides. A wide variety of screw or extruder types can be use in the process of the present invention. In addition, it is believed that because of the ease of varying process conditions and reactant feeds provided by extrusion polymerization, scaling-up of this process should not affect the product produced by the process of the present invention. The following is an example of reactive extrusion within the scope of this invention. This example is not meant in any way to limit the scope of this invention.

### Aspects of the Invention

Aspect one, a process for producing polymeric polysulfides, comprising: extruding elemental sulfur, sulfides or mixtures thereof and at least one unsaturated hydrocarbon through one or more extruders to form a polymeric polysulfide extrudate.

Aspect 2, the process according to aspect 1, wherein said elemental sulfur, sulfides or mixtures thereof is feed to said one or more extruders concurrently with said at least one unsaturated hydrocarbon.

Aspect 3, the process according to 1, wherein said elemental sulfur, sulfides or mixtures thereof is feed to said one or more extruders independently of said at least one unsaturated hydrocarbon.

Aspect 4, the process according to any of aspects 1 to 3, wherein said process is a continuous process.

Aspect 5, the process according to any of aspects 1 to 4, wherein said one or more extruders are operated at a temperature profile selected from the group of a consisting of a constant temperature along an extruder or a temperature gradient along an extruder.

Aspect 6, the process according to any of aspects 1 to 5, wherein said sulfur and at least one unsaturated hydrocarbon is fed through a sequence of extruders.

Aspect 7, the process according to any of aspects 1 to 6, wherein the extruders in the sequence of extruders are operated at different temperatures.

Aspect 8. the process according to any of aspects 1 to 7, wherein the extruders in the sequence of extruders are operated at different pressures

Aspect 9, the process according to any of aspects 1 to 8, wherein said at least one unsaturated hydrocarbon is selected from the group consisting of aliphatic unsaturated hydrocarbons and aromatic unsaturated hydrocarbons.

Aspect 10. the process according to any of aspects 1 to 8, wherein said at least one unsaturated hydrocarbon has a structure selected from the group consisting of linear structure, branched structure, heteroatomic structures, cyclic structures and mixtures thereof.

Aspect 11, the process according to any of aspects 1 to 10, wherein said at least one unsaturated hydrocarbon is selected from the group consisting of dicyclopentadiene (DCPD), cyclododecatriene (CDT), divinyl benzene (DBV), diisopropenylbenzene (DIB), ethylidene norbornene (ENB), soybean oil, linseed oil, limonene, myrcene, farnesol, farnesene, diethyleneglycol dimethacrylate and mixtures thereof.

Aspect 12, the process according to any of aspects 1 to 11, wherein said extruder is comprised of a barrel and the temperature of said barrel is between about 900° C. and 2500° C.

Aspect 13, the process according to any of aspects 1 to 12, wherein said extruder is comprised of a screw and said screw has a compression ratio between approximately 1.5:1 and 3:1.

Aspect 14, the process according to any of aspects 1 to 13, wherein said extruder is a twin screw extruder.

Aspect 15, the process according to any of aspects 1 to 14, wherein the ratio by weight of elemental sulfur, sulfides or mixtures thereof to at least one unsaturated hydrocarbon used in the process is from approximately 1:20 to approximately 20:1.

Aspect 16, the process according to any of aspects 1 to 15, wherein said extruder is comprised of a screw and a barrel and wherein said screw is rotated so as to pressurize said elemental sulfur, sulfides or mixtures thereof before injection of the at least one unsaturated hydrocarbon in to the barrel.

Aspect 17, the process according to claim any of aspects 1 to 16, further comprising the step of heating said sulfur to precondition the elemental sulfur, sulfides or mixtures thereof before it is fed to the extruder.

Aspect 18, the process according to any of aspects 1 to 17, wherein the barrel of the extruder has a plurality of temperature zones having different temperatures.

Aspect 19, the process according to any of aspects 1 to 18, wherein gases are vented from said extruder during the extrusion step.

Aspect 20, the process according to any of aspects 1 to 19, further comprising feeding a catalyst to the extruder.

Aspect 21, the process according to any of aspects 1 to 20, further comprising adding to the extruder a catalyst selected form the group consisting of zinc diethyldithiocarbamate, zinc dimethyldithiocarbamate, zinc stearate, sodium diethyldithiocarbamate, iron diethyldithiocarbamate, cobalt diethyldithiocarbamate, copper diethyldithiocarbamate, nickel diethyldithiocarbamate, thiram, thiuram, guanidine, 2-mercaptobenzothiazole, zinc 2-mercaptobenzothioazole, thiourea, benzothiazole sulfenamide, isopropylxanthate and mixtures thereof.

Aspect 22, the process according to any of aspects 1 to 21, further comprising adding to the extruder a material selected from co-monomers, fillers, H₂S suppressants, functional components, plasticizers, viscosity modifiers, antioxidants, crosslinkers, porogen, polymer resins.

Aspect 23, the process according to any of aspects 1 to 22, wherein H₂S gas is removed from the extruder.

Aspect 24, the process of any of aspects 1 to 23, further including treatment of the polymeric polysulfide extrudate by washing.

### EXAMPLES

### Example 1: Prior Art Batch Process

Seven gram of sulfur was placed in 40 mL glass vial equipped with magnetic bar stirrer. The vial was connected to a monomer feeder (addition funnel) and condenser. For safely handling H₂S gas, a gas outlet was connected to a scrubber. The vial (with sulfur) was heated to 185° C. using a metal heating block. When all the sulfur had melted, 3 gram of monomer, (a) mixture of dicyclopentadiene (DCPD) and soybean oil (SB oil) (DCPD/SB oil=50/50 by wt %), (b) cyclododecatriene (CDT), and (c) DCPD was slowly fed to the vial. As the reaction proceeded over the time of one hour, the viscosity increased to the point where the magnetic bar stirrer could no longer function. After 4 hours the reaction was stopped by turning off the heater. Residual H₂S in was purged using nitrogen and passed to scrubber for 10 min. Black colored virtuous thiopolymers were obtained. The formation of a polymeric polysulfide is evidenced by thermogravimetric analysis (TGA). Thermogravimetric analysis were recorded under nitrogen (N2) atmosphere with heat increment of 20° C./min.

Control reactants: elemental sulfur and DCPD
(a) Elemental sulfur: 5% weight loss temperature was 206° C. and no residues remained at 800° C. (Error! Reference source not found.-entry 10).
(b) DCPD: 5% weight loss temperature was 43° C. and no residues remained at 800° C. (Error! Reference source not found.-entry 11).

Batch process product: TGA analysis of the products of the batch process evidence inverse vulcanization polymerizations occurred. The amount of residues at elevated temperature (800° C. under N₂) correlated well with initial feed amount of monomer(s).
(a) Examples 2: Inventive Reactive Extrusion Reactions—Multi-pass Reactive Extrusion
   Sulfur/DCPD/SB oil (70/15/15 by wt %). TGA analysis of the product showed that 5% weight loss temperature was 229° C. About 28 wt % of residues remained at 800° C. (Error! Reference source not found.-entry 1). The results indicate polymerization was successfully conducted and the amount of residue at 800° C. correlated well with initial feed amount of monomer(s).
(b) Sulfur/CDT (70/30 by wt %). TGA analysis of the product showed that 5% weight loss temperature was 234° C. and 33 wt % of residues remained at 800° C. (Error! Reference source not found.-entry 2Error! Reference source not found.). The results indicate polymerization was successfully conducted and the amount of residue at 800° C. correlated well with initial feed amount of monomer(s).
(c) Sulfur/DCPD (70/30 by wt %). TGA analysis of the product showed 5% weight loss temperature was 264° C. and 32 wt % of residues remained at 800° C. (Error! Reference source not found.-entry 3Error! Reference source not found.). The results indicate polymerization was successfully conducted and the amount of residue at 800° C. correlated well with initial feed amount of monomer(s).

Combinations of elemental sulfur (S) and unsaturated hydrocarbons: dicyclopentadiene (DCPD), soybean oil (SB oil), cyclododecatriene (trans,trans,trans-1,5,9-, or CDT) and 1,3-diisopropenylbenzez (1,3-DIB) were reacted in a single stage extruder. The extruder was purged with high melt flow rate polypropylene prior to use. A pre-mix of the elemental sulfur and the unsaturated hydrocarbons combination was prepared and fed directly to the extruder. The reaction temperature (i.e., inside the extruder) was between 2000 to 2200° C. During the reactive extrusion, Carusorb® (product of Carus Corp.) containing columns under vacuum were installed for quenching released H₂S. Shear rate in the extruder was manually controlled and 25 to 75% power was used (rotation range: 0-35 rpm). The materials were passed through the extruder three times in order to maximize monomer(s) conversion and homogenization of polymeric thiopolymer.

Three pre-mixes were prepared for inverse vulcanization reactive extrusions: (a) sulfur/dicyclopentadiene/soybean oil (70/15/15 by wt %), (b) sulfur/cyclododecatriene (70/30 by wt %) and (c) sulfur/dicyclopentadiene (70/30, by wt %). All pre-mixes were manually fed to the extruder.
(a) Pre-mix of Sulfur/dicyclopentadiene/soybean oil (70/15/15 by wt %). The premix was manually fed to a single screw extruder. Reaction temperature was set as 220° C., higher than a typical (i.e., T=185° C.) batch run inverse vulcanization reaction temperature, in order to expedite the rate of polymerization. Shear power (rate) was adjusted from 70% to 25% (ca. 25 to 9 rpm). The first pass through the extruder was predominantly the chemical reaction (polymerization) of elemental sulfur and monomers. In order to provide for good mixing, 70% power used. Two additionally passed at lower shear rate (25% power) through the extruder were run to provide uniform physical properties. The filaments i.e., thiopolymer, formed were black colored. The first and second extrudates were manually pelletized prior to re-extruding. TGA analysis of the 3^{rd} pass extrudate showed a 5% weight loss temperature of 224° C. and 25 wt % of residues remained at 800° C. (Error! Reference source not found.-entry 4). The results indicate polymerization was successfully conducted and the amount of residue at 800° C. correlated well with initial feed amount of monomer(s). (Error! Reference source not found.-entry 1).
(b) Pre-mix of sulfur/cyclododecatriene (70/30 by wt %). The premix was manually fed to a single screw extruder. Reaction temperature was 220-200° C. The procedure of example 3(a) of three passes through the extruder was employed. Filaments were black colored and brittle. The product was manually pelletized. TGA analysis of the 3^{rd} pass extrudate showed a 5% weight loss temperature of 226° C. and 21 wt % of residues remained at 800° C. The results indicate polymerization was successfully conducted and the amount of residue at 800° C. correlated well with initial feed amount of monomer(s). (Error! Reference source not found.-entry 5).
(c) Pre-mix of sulfur/dicyclopentadiene (70/30, by wt %) The premix was manually fed to a single screw extruder using the procedure set out in example
(a). Filaments were black colored and brittle. The product was manually pelletized.
TGA analysis of the 3^{rd} pass sample showed a 5% weight loss temperature of 237° C. and 27 wt % of residues remained at 800° C. The results indicate polymerization was successfully conducted and the amount of residue at 800° C. correlated well with initial feed amount of monomer(s). (Error! Reference source not found.-entry 6).

### Examples 3: Inventive Reactive Extrusion Reactions—Catalytic Reactive Extrusion

Combinations of elemental sulfur (S) unsaturated hydrocarbons: dicyclopentadiene (DCPD), soybean oil (SB oil), cyclododecatriene (trans,trans,trans-1,5,9-, or CDT) and 1,3-diisopropenylbenzez (1,3-DIB), and catalyst (zinc diethyldithiocarbamate (ZnDC)) were reacted in a single stage extruder. The extruder was purged with high melt flow rate high impact polystyrene (HIPS) prior to use. A pre-mix of the elemental sulfur, the unsaturated hydrocarbons, and the catalyst was prepared and small portion of the pre-mix was used as sacrificial reactant for additional cleaning of extruder. After cleaning/purging, the pre-mix was fed directly to the extruder. The reaction temperature (i.e., inside extruder) was between 185° to 2200° C. During the reactive extrusion, Carusorb® (product of Carus Corp.) containing columns under vacuum were installed for quenching released H₂S. Shear rate in the extruder was manually controlled up to 75% power was used (rotation range: 0-35 rpm).

Three pre-mixes were prepared for inverse vulcanization reactive extrusions (total weight was around 300 gram): (a) sulfur/dicyclopentadiene (70/30, by wt %) as a control sample, (b) sulfur/dicyclopentadiene/ZnDC (70/30/1, by wt %), (c) sulfur/dicyclopentadiene/ZnDC (70/30/1, by wt %). All pre-mixes were manually fed to the extruder.
(a) Pre-mix of Sulfur/dicyclopentadiene (70/30 by wt %). The premix was manually fed to a single screw extruder. Reaction temperature was 200° C. Shear power (rate) was adjusted around 70% (ca. 25 rpm). A small portion of each pre-mix (20-30 gram) was used as a sacrificial reactant for additional cleaning of extruder which improve product quality by removal of residual purging polymers. Filaments (i.e., thiopolymer) were black colored and manually pelletized. TGA analysis of the extrudate showed a 5% weight loss temperature of 249° C. and 31 wt % of residues remained at 800° C. (Error! Reference source not found.-entry 7). The results indicate polymerization was successfully conducted and the amount of residue at 800° C. correlated well with initial feed amount of monomer(s).
(b) Pre-mix of Sulfur/dicyclopentadiene/ZnDC (70/30/1 by wt %). The premix was manually fed to a single screw extruder. Reaction temperature was 200° C. The procedure of example 4(a) was employed. Filaments were black colored and brittle. The product was manually pelletized. TGA analysis of the extrudate showed a 5% weight loss temperature of 256° C. and 27 wt % of residues remained at 800° C. (Error! Reference source not found.-entry 8). The results indicate polymerization was successfully conducted and the amount of residue at 800° C. correlated well with initial feed amount of monomer(s). The catalytic reaction showed no adverse effects on the thermal properties of the produced polymeric polysulfides.
(c) Pre-mix of Sulfur/dicyclopentadiene/ZnDC (70/30/1 by wt %). The premix was manually fed to a single screw extruder. Reaction temperature was 185° C. in order to verify the effect of the catalyst in low temperature reaction. The procedure of example 4(a) was employed. Filaments were black colored and brittle. The product was manually pelletized. TGA analysis of the sample showed a 5% weight loss temperature was 260° C. and 28 wt % of residues remained at 800° C. (Error! Reference source not found.-entry 9). The results indicate polymerization was successfully conducted and the amount of residue at 800° C. correlated well with initial feed amount of monomer(s). At the low temperature reaction, the catalytic reactive extrusion reaction showed no adverse effects on the thermal properties of the produced polymeric polysulfides.

TABLE 1
TGA of Polymeric Polysulfide Samples
and Reactant Raw Materials.

| | | | Reaction | 5% wt | Residue |
|---|---|---|---|---|---|
| | | | temperature | loss | wt % |
| Entry | Composition | Procedure | (° C.) | (° C.) | at 800° C. |
| 1 | S/DCPD/SB oil | Batch | 185 | 229 | 28 |
| 2 | S/CDT | Batch | 185 | 234 | 33 |
| 3 | S/DCPD | Batch | 185 | 264 | 32 |
| 4 | S/DCPD/SB | RE | 220 | 224 | 25 |
| | oil^{a} | | | | |
| 5 | S/CDT^{a} | RE | 200-220 | 226 | 21 |
| 6 | S/DCPD^{a} | RE | 200 | 237 | 27 |
| 7 | S/DCPD^{b} | RE | 200 | 249 | 31 |
| 8 | S/DCPD^{b} | RE/catalytic | 200 | 256 | 27 |
| 9 | S/DCPD^{b} | RE/catalytic | 185 | 260 | 28 |
| 10 | Elemental S^{c} | — | — | 206 | 0 |
| 11 | DCPD^{c} | — | — | 43 | 0 |

General condition: S/M = 70/30 (by wt %); under N₂ condition; heat ramp = 20° C./min;
^{a}multi-pass sample (3^{rd} pass);
^{b}high purity sample, single pass, obtained samples after the extrusion of sacrificial pre-mix;
^{c}reactant raw materials.

The polymeric polysulfide samples were pulverized and washed with an aqueous NaOH solution to remove residual H₂S. GC analysis of the headspace was performed at 35° C. for determination of H₂S. No H₂S was detected from any of the polymeric polysulfide samples.

The polymeric polysulfide from S/DCPD were examined via X-ray diffraction for free sulfur contents. No free sulfur was detected in sample that had been washed with an aqueous NaOH solution.

From the foregoing, it will be seen that this invention is one well adapted to attain all the ends and objects hereinabove set forth together with other advantages which are obvious and which are inherent to the process. It will be understood that certain features and subcombinations are of utility and may be employed without reference to other features and subcombinations. This is contemplated by and is within the scope of this invention. Since many possible embodiments may be made of the invention without departing from the scope thereof, it is to be understood that all matter herein set forth is to be interpreted as illustrative and not in a limiting sense.

1. A process for producing polymeric polysulfides, comprising: extruding elemental sulfur, sulfides or mixtures thereof and at least one unsaturated hydrocarbon through one or more extruders to form a polymeric polysulfide extrudate.

2. The process according to claim 1, wherein said elemental sulfur, sulfides or mixtures thereof is feed to said one or more extruders concurrently with said at least one unsaturated hydrocarbon.

3. The process according to claim 1, wherein said elemental sulfur, sulfides or mixtures thereof is feed to said one or more extruders independently of said at least one unsaturated hydrocarbon.

4. The process according to claim 1, wherein said process is a continuous process.

5. The process according to claim 1, wherein said one or more extruders are operated at a temperature profile selected from the group of a consisting of a constant temperature along an extruder or a temperature gradient along an extruder.

6. The process according to claim 1, wherein said sulfur and at least one unsaturated hydrocarbon is fed through a sequence of extruders.

7. The process according to claim 6, wherein the extruders in the sequence of extruders are operated at different temperatures.

8. The process according to claim 6, wherein the extruders in the sequence of extruders are operated at different pressures

9. The process according to claim 1, wherein said at least one unsaturated hydrocarbon is selected from the group consisting of aliphatic unsaturated hydrocarbons and aromatic unsaturated hydrocarbons.

10. The process according to claim 1, wherein said at least one unsaturated hydrocarbon has a structure selected from the group consisting of linear structure, branched structure, heteroatomic structures, cyclic structures and mixtures thereof.

11. The process according to claim 1, wherein said at least one unsaturated hydrocarbon is selected from the group consisting of dicyclopentadiene (DCPD), cyclododecatriene (CDT), divinyl benzene (DBV), diisopropenylbenzene (DIB), ethylidene norbornene (ENB), soybean oil, linseed oil, limonene, myrcene, farnesol, farnesene, diethyleneglycol dimethacrylate and mixtures thereof.

12. The process according to claim 1, wherein said extruder is comprised of a barrel and the temperature of said barrel is between about 900° C. and 250° C.

13. The process according to claim 1, wherein said extruder is comprised of a screw and said screw has a compression ratio between approximately 1.5:1 and 3:1.

14. The process according to claim 1, wherein said extruder is a twin screw extruder.

15. The process according to claim 1, wherein the ratio by weight of elemental sulfur, sulfides or mixtures thereof to at least one unsaturated hydrocarbon used in the process is from approximately 1:20 to approximately 20:1.

16. The process according to claim 1, wherein said extruder is comprised of a screw and a barrel and wherein said screw is rotated so as to pressurize said elemental sulfur, sulfides or mixtures thereof before injection of the at least one unsaturated hydrocarbon in to the barrel.

17. The process according to claim 1, further comprising the step of heating said sulfur to precondition the elemental sulfur, sulfides or mixtures thereof before it is fed to the extruder.

18. The process according to claim 12, wherein the barrel of the extruder has a plurality of temperature zones having different temperatures.

19. The process according to claim 1, wherein gases are vented from said extruder during the extrusion step.

20. The process according to claim 1, further comprising feeding a catalyst to the extruder.

21. The process according to claim 1, further comprising adding to the extruder a catalyst selected form the group consisting of zinc diethyldithiocarbamate, zinc dimethyldithiocarbamate, zinc stearate, sodium diethyldithiocarbamate, iron diethyldithiocarbamate, cobalt diethyldithiocarbamate, copper diethyldithiocarbamate, nickel diethyldithiocarbamate, thiram, thiuram, guanidine, 2-mercaptobenzothiazole, zinc 2-mercaptobenzothioazole, thiourea, benzothiazole sulfenamide, isopropylxanthate and mixtures thereof.

22. The process according to claim 1, further comprising adding to the extruder a material selected from co-monomers, fillers, H₂S suppressants, functional components, plasticizers, viscosity modifiers, antioxidants, crosslinkers, porogen, polymer resins.

23. The process according to claim 1, wherein H₂S gas is removed from the extruder.

24. The process of claim 1, further including treatment of the polymeric polysulfide extrudate by washing.
